(19) United States
(12) Patent Application Publication
(10) Pub. No.: US 2023/0368258 A1
(43) Pub. Date: Nov. 16, 2023

(54) SYSTEM AND METHOD OF CONNECTION BETWEEN METAVERSE OF VIRTUAL WORLD AND CONTACT CENTER OF REAL WORLD

(71) Applicant: Buttle Information Systems Co., Ltd., Seoul (KR)

(72) Inventors: Kyoung Jing KIM, Seoul (KR); Young Han LEE, Seoul (KR)

(73) Assignee: Buttle Information Systems Co., Ltd., Seoul (KR)

(21) Appl. No.: 17/811,294

(22) Filed: Jul. 7, 2022

(30) Foreign Application Priority Data
May 12, 2022 (KR) 10-2022-0058551

(51) Int. Cl. G06Q 30/06

(52) U.S. Cl. CPC G06Q 30/0613

(57) ABSTRACT

Provided is a connection system for connecting a metaverse of a virtual world and a contact center of a real world, the connection system including a contact center provider configured to provide a virtual contact center in at least one metaverse platform and to collect a consultation request through the provided virtual contact center; a validity determiner configured to, in response to the collected consultation request, collect customer information on a user that requests a consultation and determine a validity of the user based on the collected customer information; and a consultation processing unit configured to provide the customer information on the user of which the validity is determined to a server of a real contact center and to connect a consultation channel between a user in the at least one metaverse platform and the real contact center.

### CROSS-REFERENCE TO RELATED APPLICATIONS

This application claims the benefit under 35 USC § 119(a) of Korean Patent Application No. 10-2022-0058551 filed on May 12, 2022 in the Korean Intellectual Property Office, the entire disclosure of which is incorporated herein by reference for all purposes.

### BACKGROUND

### 1. Field

At least one example embodiment relates to technology for connecting a metaverse of a virtual world and a contact center of a real world.

### 2. Description of Related Art

A metaverse is a compound word of English words “meta” meaning “virtual”, “transcendent”, etc., and “universe” meaning the universe and refers to a three-dimensional (3D) virtual world in which social/economic/cultural activities are performed as in the real world. The metaverse is a concept that has evolved one step further than the virtual reality (VR) (e.g., cutting-edge technology that allows a user to have real-world experience in the virtual world created by a computer). In such metaverse, the user may engage in social/cultural activities similar to the reality beyond enjoying games or the virtual reality using an avatar.

In particular, the metaverse began to spread amid the commercialization of 5G with features of high-speed, hyper-connection, and ultra-low latency, and the COVID-19 pandemic that hit the world in 2020. That is, with the commercialization of 5G, technology capable of implementing virtual reality (VR), augmented reality (AR), mixed reality (MR), etc., has developed and the metaverse is drawing attention as a non-face-to-face and online trend is spreading due to the COVID-19 crisis.

In the virtual world, such as Gathertown, ZEPETO, ifland, etc., communication takes place only within each metaverse. Therefore, although an avatar of the virtual world visits a pizza store and orders pizza using independent cryptocurrency in each metaverse even in a well-made metaverse, there is no way to have the pizza delivered to “me” in the real world.

A user that accesses the virtual world of metaverse uses a personal computer (PC) or a mobile device and may use chat, voice, and video channels.

Patent documents may include Korean Patent Registration No. 10-2376390 titled “method and apparatus for providing a metaverse service”, Korean Patent Registration No. 10-1923723 titled “metaverse client terminal and method for providing metaverse space for user interaction”, and Korean Patent Laid-Open Publication No. 10-2012-0003588 titled “healthcare system having function of interworking with metaverse and method of performing the same”.

### SUMMARY

An objective of at least one example embodiment is to connect a virtual world and a real world such that a user visiting a consultation center of the virtual world implemented in a metaverse may make a consultation through a consultation center of the real world using chat, voice, and video channels.

An objective of at least one example embodiment is to perform general inquiry, production subscription, purchase, and payment actions performed in a contact center (or a consultation center) through a connection from various metaverse platforms to a customer service center of the real world.

According to an aspect of at least one example embodiment, there is provided a connection system for connecting a metaverse of a virtual world and a contact center of a real world, the connection system including a contact center provider configured to provide a virtual contact center in at least one metaverse platform and to collect a consultation request through the provided virtual contact center; a validity determiner configured to, in response to the collected consultation request, collect customer information on a user that requests a consultation and determine a validity of the user based on the collected customer information; and a consultation processing unit configured to provide the customer information on the user of which the validity is determined to a server of a real contact center and to connect a consultation channel between a user in the at least one metaverse platform and the real contact center.

The consultation processing unit may be configured to connect a consultation channel communicable using at least one method among chat, voice, and video.

The connection system may further include a billing processing unit configured to relay a billing for a virtual order request that occurs in the at least one metaverse platform to be processed in an actual financial institution.

The connection system may further include an order processing unit configured to generate order information corresponding to the billed virtual order request and to deliver the generated order information to a store terminal of the real world.

According to an aspect of at least one example embodiment, there is provided a connection system for connecting a contact center in a metaverse of a virtual world, the connection system including a contact center provider configured to provide a virtual contact center in a first metaverse platform and to collect a consultation request through the provided virtual contact center; a validity determiner configured to, in response to the collected consultation request, collect customer information on a user that requests a consultation and determine a validity of the user based on the collected customer information; and a consultation processing unit configured to provide the customer information on the user of which the validity is determined to a contact center in a second metaverse platform and to connect a consultation channel between a user in the first metaverse platform and the contact center in the second metaverse platform.

The consultation processing unit may be configured to, in response to a termination of a consultation channel between contact centers in the second metaverse platform, provide the customer information on the user of which the validity is determined to a server of a real contact center and connect a consultation channel between a user in the at least one metaverse platform and the real contact center.

According to an aspect of at least one example embodiment, there is provided a method of connecting a metaverse of a virtual world and a contact center of a real world, the method including providing a virtual contact center in at least one metaverse platform; collecting a consultation request through the provided virtual contact center; in response to the collected consultation request, collecting customer information on a user that requests a consultation; determining a validity of the user based on the collected customer information; and providing the customer information on the user of which the validity is determined to a server of a real contact center and connecting a consultation channel between a user in the at least one metaverse platform and the real contact center.

The connecting of the consultation channel may include connecting a consultation channel communicable using at least one method among chat, voice, and video.

The method of connecting the metaverse of the virtual world and the contact center of the real world may further include relaying a billing for a virtual order request that occurs in the at least one metaverse platform to be processed in an actual financial institution.

The method of connecting the metaverse of the virtual world and the contact center of the real world may further include generating order information corresponding to the billed virtual order request; and delivering the generated order information to a store terminal of the real world.

According to an aspect of at least one example embodiment, there is provided a method of connecting a contact center in a metaverse of a virtual world, the method including providing a virtual contact center in a first metaverse platform and collecting a consultation request through the provided virtual contact center; in response to the collected consultation request, collecting customer information on a user that requests a consultation; determining a validity of the user based on the collected customer information; providing the customer information on the user of which the validity is determined to a contact center in a second metaverse platform and connecting a consultation channel between a user in the first metaverse platform and the contact center in the second metaverse platform; in response to a termination of a consultation channel between contact centers in the second metaverse platform, providing the customer information on the user of which the validity is determined to a server of a real contact center; and connecting a consultation channel between a user in the first metaverse platform and the contact center in the second metaverse platform.

According to some example embodiments, it is possible to provide technology for connecting a virtual world and a real world such that a user visiting a consultation center of the virtual world implemented in a metaverse may make a consultation through a consultation center of the real world using chat, voice, and video channels.

Also, according to some example embodiments, it is possible to perform general inquiry, production subscription, purchase, and payment actions performed in a contact center (or a consultation center) through a connection from various metaverse platforms to a customer service center of the real world.

The aforementioned features and effects of the disclosure will be apparent from the following detailed description related to the accompanying drawings and accordingly those skilled in the art to which the disclosure pertains may easily implement the technical spirit of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1A is a diagram illustrating an example of an overall system that connects a virtual metaverse and a real contact center according to an example embodiment;

FIG. 1B is a diagram illustrating an example of an overall system that connects between virtual metaverses according to an example embodiment;

FIG. 2 is a diagram illustrating an example of a connection system according to an example embodiment;

FIG. 3 is a flowchart illustrating an example of a method of connecting a virtual metaverse and a real contact center according to an example embodiment;

FIG. 4 is a flowchart illustrating an example of a method of connecting between virtual metaverses according to an example embodiment;

FIG. 5 illustrates an example of an app-linked chat consultation according to an example embodiment;

FIG. 6 illustrates an example of a social network service (SNS)-linked chat consultation according to an example embodiment;

FIG. 7 illustrates an example of an interworking video consultation according to an example embodiment;

FIG. 8 illustrates an example of switching to a voice consultation during a chat consultation according to an example embodiment;

FIG. 9 illustrates an example of switching to a video consultation during a chat consultation according to an example embodiment; and

FIG. 10 illustrates an example of switching to a video consultation during a voice consultation according to an example embodiment.

### DETAILED DESCRIPTION

Specific structural or functional descriptions related to example embodiments according to the concept of the present invention set forth herein are simply provided to explain the example embodiments according to the concept of the present invention and the example embodiments according to the concept of the present invention may be implemented in various forms and are not limited to the example embodiments described herein.

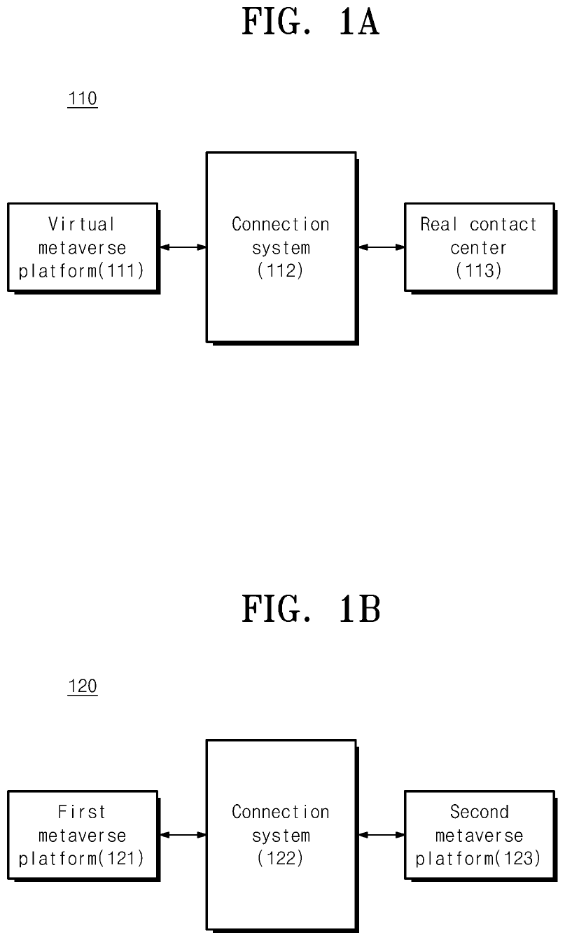

FIG. 1A is a diagram illustrating an example of an overall system 110 that connects a virtual metaverse and a real contact center according to an example embodiment.

The overall system 110 may connect a virtual metaverse, that is, a metaverse of a virtual world and a real contact center 113, that is, a contact center of a real world.

That is, the overall system 110 may connect the virtual world and the real world such that a user visiting a consultation center of the virtual world implemented in the metaverse provided from a virtual metaverse platform 111 through a connection system 112 according to an example embodiment may make a consultation through the real contact center 113 using chat, voice, and video channels.

The overall system 110 refers to technology for interconnecting a metaverse platform and a customer center of the real world and a company that runs a contact center may outperform an issue of having to prepare each consultation personnel for each metaverse having many users by using an existing customer center.

Also, a metaverse platform operation company may have technology for expanding a metaverse and connecting the metaverse to the real world. A metaverse user may use a consultation service of the real world, such as inquiry, contract, order, etc., even in the virtual world.

In the case of using the overall system 110, it is possible to perform general inquiry, product subscription, purchase, and payment actions performed in a contact center through connection from various metaverse platforms to a customer service center of the real world.

FIG. 1B is a diagram illustrating an example of an overall system 120 that connects between virtual metaverses according to an example embodiment.

While FIG. 1A illustrates a connection between a customer on a virtual metaverse platform and a real contact center, FIG. 1B illustrates a connection between customers on the virtual metaverse platform or between a customer on the virtual metaverse platform and a consultant of the customer center.

To this end, the overall system 120 may include a first metaverse platform 121, a connection system 122, and a second metaverse platform 123.

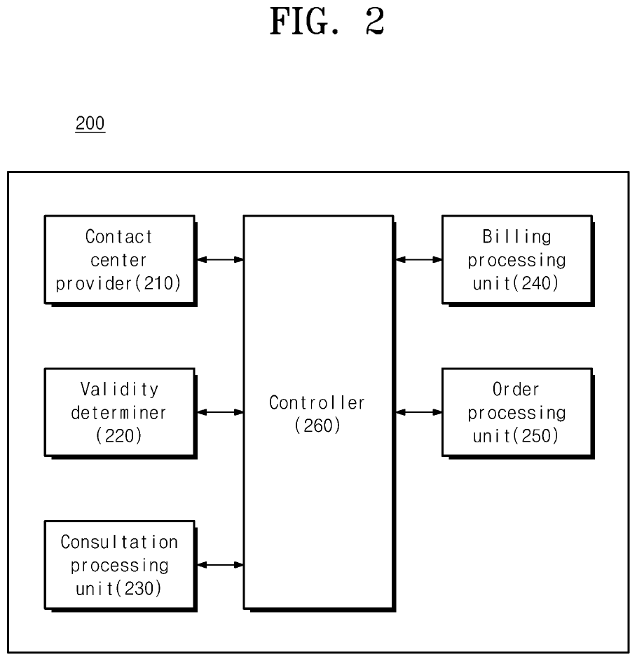

FIG. 2 is a diagram illustrating an example of a connection system 200 according to an example embodiment.

The connection system 200 according to an example embodiment may connect between a customer on a virtual metaverse platform and a real contact center or between customers on the virtual metaverse platform or between a customer on the virtual metaverse platform and a consultant of the customer center.

That is, the connection system 200 according to an example embodiment may provide technology for connecting a virtual world and a real world such that a user visiting a consultation center of the virtual world implemented in a metaverse may make a consultation through a consultation center of the real world using chat, voice, and video channels. Also, the connection system 200 may perform general inquiry, product subscription, purchase, and payment actions performed in a contact center (or a consultation center) through a connection from various metaverse platforms to a customer service center of the real world.

To this end, the connection system 200 according to an example embodiment may include a contact center provider 210, a validity determiner 220, and a consultation processing unit 230.

Initially, the contact center provider 210 according to an example embodiment may provide a virtual contact center (a contact center) in at least one metaverse platform and may collect a consultation request through the provided virtual contact center.

The contact center may resolve customer inquiries through various channels, such as chat, voice, and video, and may also perform various tasks concluding a contract and paying an expense through an identity verification procedure.

A conventional metaverse platform has channels capable of using chat, voice, and video, but has some constraints in that communication is allowable only between users in the same metaverse platform.

The connection system 200 according to an example embodiment refers to technology for interconnecting a metaverse platform and a customer center of the real world through the contact center provider 210 and a company that runs a contact center may outperform an issue of having to prepare each consultation personnel for each metaverse having many users by using an existing customer center.

Also, a metaverse platform operation company may have technology for expanding a metaverse and connecting the metaverse to the real world. A metaverse user may use a consultation service of the real world, such as inquiry, contract, order, etc., even in the virtual world.

In response to the collected consultation request, the validity determiner 220 according to an example embodiment may collect customer information on a user that requests a consultation and may determine a validity of the user based on the collected customer information.

The customer information may include personal information of a customer or authentication information and may include, for example, a name, a resident registration number, a telephone number, an ID, a password, and the like.

The consultation processing unit 230 according to an example embodiment may provide the customer information on the user of which the validity is determined to a server of a real contact center and may connect a consultation channel between a user in the at least one metaverse platform and the real contact center.

For example, the consultation processing unit 230 may connect a consultation channel communicable using at least one method among chat, voice, and video.

The connection system 200 according to an example embodiment may further include a billing processing unit 240 configured to relay a billing for a virtual order request that occurs in the at least one metaverse platform to be processed in an actual financial institution.

For example, one of the fields of great interest in the metaverse is a performance field and a performance fee made through a metaverse platform may be billed through the billing processing unit 240.

For example, the billing processing unit 240 may relay a performance fee paid to a related industry to be billed through a financial institution in compliance with a royalty collection regulation of the Korea Music Copywrite Association.

The connection system 200 according to an example embodiment may further include an order processing unit 250 configured to generate order information corresponding to the billed virtual order request and to deliver the generated order information to a store terminal of the real world.

The order information may include product information of a product desired to be ordered and personal information for delivery. The product information may include identification information capable of identifying the corresponding product, a product name, and a selection option, and the personal information may include personal information, such as a name, an address, and a telephone number of a person who places an order.

The order information input to the metaverse platform may be provided to the store terminal of the real world, such that an actual order may be placed.

A channel may be connected between a user in the virtual world and a user (a consultant) in another virtual world.

In this case, the contact center provider 210 may provide a virtual contact center in a first metaverse platform and may collect a consultation request through the provided virtual contact center.

Also, in response to the collected consultation request, the validity determiner 220 may collect customer information on a user that requests a consultation and may determine a validity of the user based on the collected customer information. The consultation processing unit 230 may provide the customer information on the user of which the validity is determined to a contact center in a second metaverse platform and to connect a consultation channel between a user in the first metaverse platform and the contact center in a second metaverse platform.

Also, in response to a termination of a consultation channel between contact centers in the second metaverse platform, the consultation processing unit 230 may provide the customer information on the user of which the validity is determined to a server of a real contact center and connect a consultation channel between a user in the at least one metaverse platform and the real contact center.

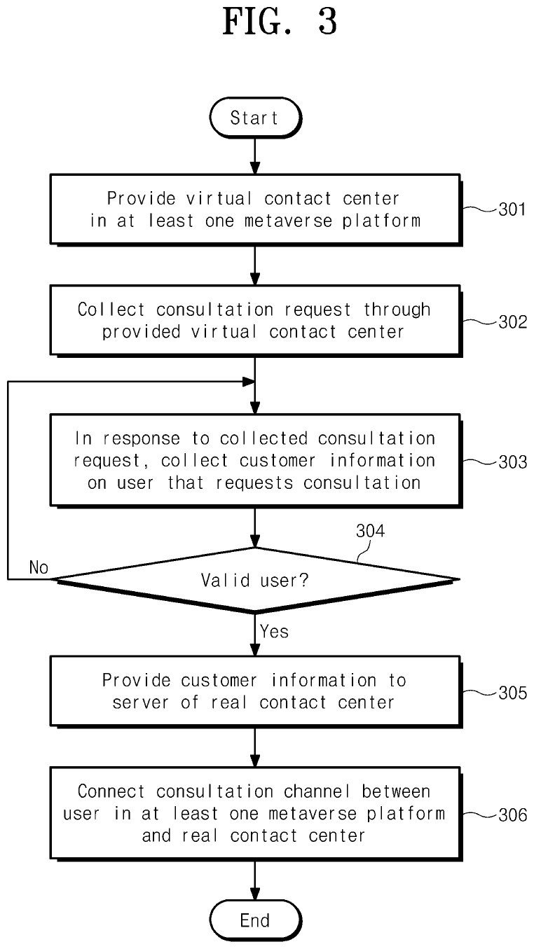

FIG. 3 is a flowchart illustrating an example of a method of connecting a virtual metaverse and a real contact center according to an example embodiment.

In operation 301, the method of connecting the virtual metaverse and the real contact center according to an example embodiment may provide a virtual contact center in at least one metaverse platform.

The method of connecting the virtual metaverse and the real contact center according to an example embodiment may collect a consultation request through the provided virtual contact center in operation 302, and, in response to the collected consultation request, collect customer information on a user that requests a consultation in operation 303.

In operation 304, the method of connecting the virtual metaverse and the real contact center according to an example embodiment may determine a validity of the user, that is, whether the user is a valid user based on the collected customer information.

When the user is determined as the valid user as a determination result of operation 304, the method of connecting the virtual metaverse and the real contact center according to an example embodiment may provide the customer information on the user of which the validity is determined to a server of a real contact center in operation 305 and may connect a consultation channel between a user in the at least one metaverse platform and the real contact center in operation 306.

For example, to connect the consultation channel, a consultation channel communicable using at least one method among chat, voice, and video may be connected.

On the contrary, when the user is determined as an invalid user as a determination result of operation 304, the method of connecting the virtual metaverse and the real contact center according to an example embodiment may return operation 303 and, in response to the collected consultation request, perform again the process of collecting customer information on the user that requests a consultation.

The method of connecting the virtual metaverse and the real contact center according to an example embodiment may relay a billing for a virtual order request that occurs in the at least one metaverse platform to be processed in an actual financial institution.

Also, the method of connecting the virtual metaverse and the real contact center according to an example embodiment may generate order information corresponding to the billed virtual order request, and may deliver the generated order information to a store terminal of the real world.

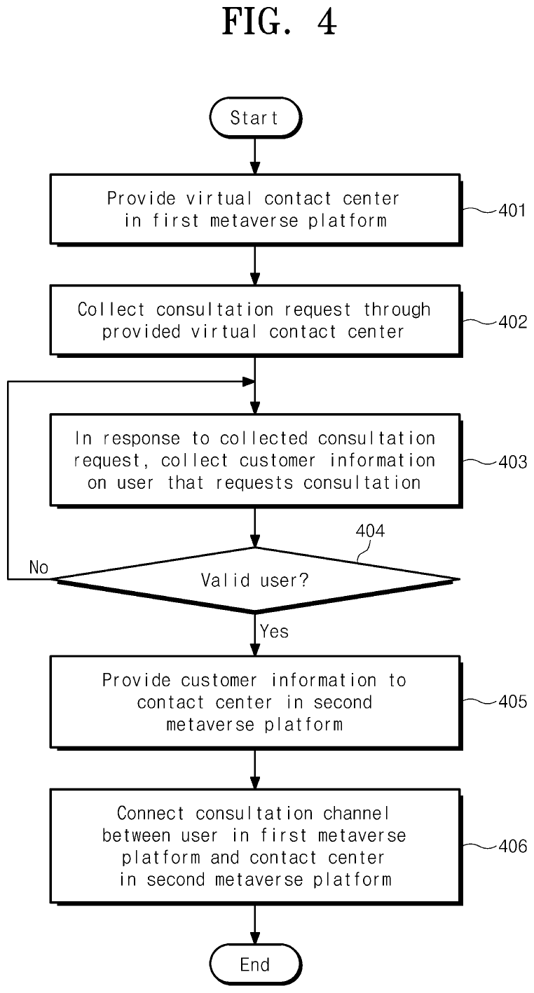

FIG. 4 is a flowchart illustrating an example of a method of connecting between virtual metaverses according to an example embodiment.

The method of connecting between virtual metaverses according to an example embodiment may provide a virtual contact center in a first metaverse platform in operation 401 and may collect a consultation request through the provided virtual contact center in operation 402.

In operation 403, in response to the collected consultation request, the method of connecting between virtual metaverses according to an example embodiment may collect customer information on a user that requests a consultation.

In operation 404, the method of connecting between virtual metaverses according to an example embodiment may determine a validity of the user based on the collected customer information and may determine whether the user is a valid user.

Also, the method of connecting between virtual metaverses according to an example embodiment may provide the customer information on the user of which the validity is determined to a contact center in a second metaverse platform in operation 405 and may connect a consultation channel between a user in the first metaverse platform and the contact center in the second metaverse platform in operation 406.

To connect the consultation channel, the method of connecting between virtual metaverses according to an example embodiment may, in response to a termination of a consultation channel between contact centers in the second metaverse platform, provide the customer information on the user of which the validity is determined to a server of a real contact center and may connect a consultation channel between a user in the first metaverse platform and the contact center in the second metaverse platform.

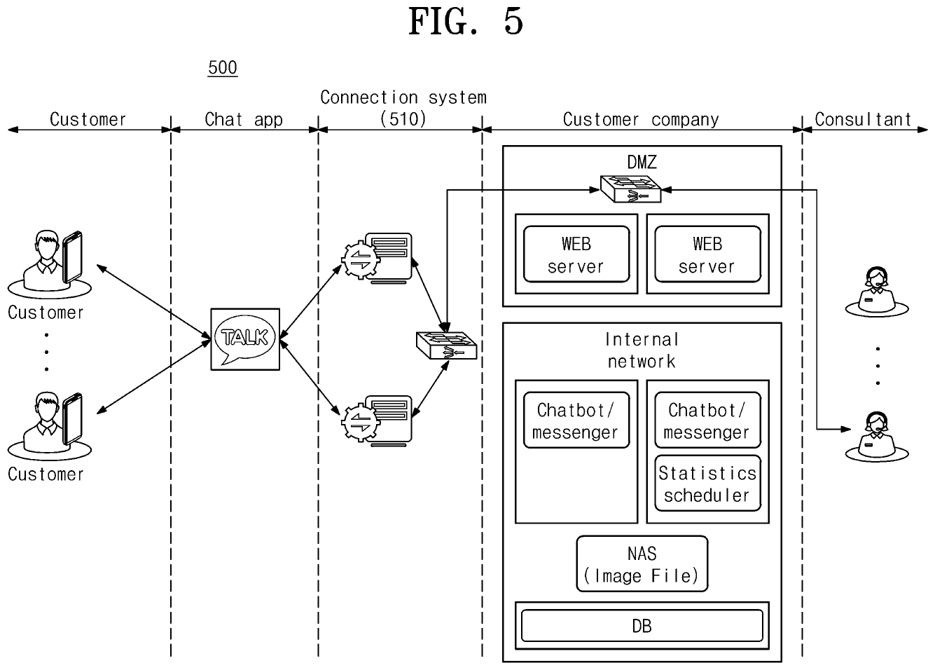

FIG. 5 illustrates an example 500 of an app-linked chat consultation according to an example embodiment.

A connection system 510 according to the present invention may connect a consultation channel between a customer using a metaverse platform and a consultant of a consultant of a customer company in a real world.

For example, when the customer is connected to a chat app provided on the metaverse platform, the connection system 510 may provide a virtual contact center to the customer connected to the chat app.

The virtual contact center may be accessible through the chat app and the customer may request a consultation through the provided virtual contact center.

The connection system 510 may collect a consultation request from the customer and, in response to the collected consultation request, collect customer information on the customer that requests a consultation.

Also, the connection system 510 may determine a validity of the customer based on the collected customer information, and may providing the customer information on the customer of which the validity is determined to a server of a real contact center.

In FIG. 5, the server of the real contact center may be interpreted to include all of a web server, an internal network, a NAS, a database (DB), and the like.

Also, the server of the real contact center may connect a consultation channel between a customer in at least one metaverse platform and a consultant of the real contact center.

In this manner, the connection system 510 may connect the consultation channel with a consultant of a customer company in the real world during a chat consultation.

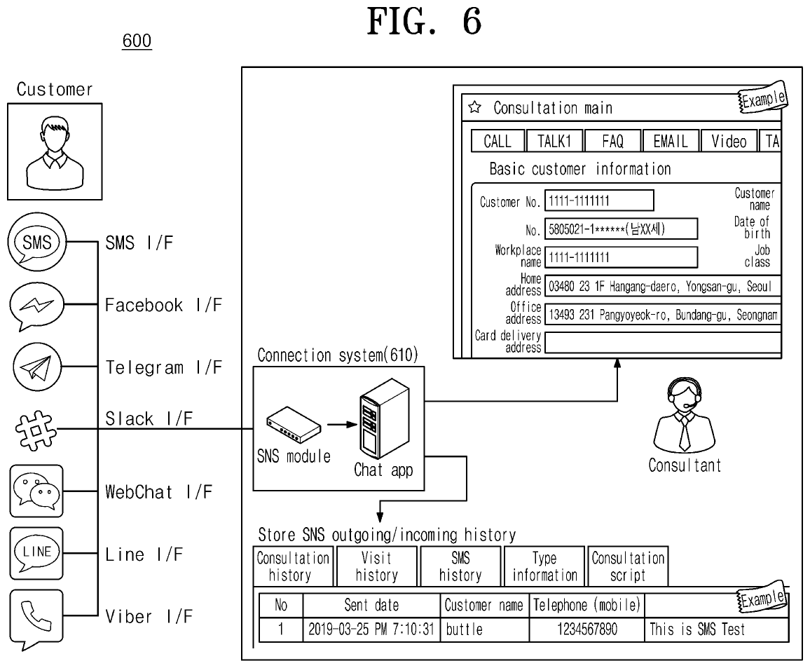

FIG. 6 illustrates an example 600 of a social network service (SNS)-linked chat consultation according to an example embodiment.

A connection system 610 according to the present invention may connect a consultation channel between a customer using a metaverse platform through an SNS module and a consultation app and a consultant of a customer company in a real world.

For example, when the customer is connected to an SNS provided on the metaverse platform, the connection system 610 may provide a virtual contact center to the customer connected to the SNS.

In detail, for example, the SNS may include a general short messaging service (SMS), Facebook, Telegram, Slack, WebChat, Line, Viber, etc., and may be interpreted as the metaverse platform provided from such SNS or an icon or some software on the metaverse platform.

The virtual contact center may be accessible through the SNS and the customer may request a consultation through the provided virtual contact center.

The connection system 610 may collect a consultation request from the customer and, in response to the collected consultation request, collect customer information on the customer that requests a consultation.

Since only a user that inputs personal information or is registered in advance may use the SNS, the connection system 610 may collect information used to access the SNS as the customer information on the customer that requests the consultation.

Also, the connection system 610 may determine a validity of the customer based on the collected customer information used to access the SNS, and may provide the customer information on the customer of which the validity is determined to a server of a real contact center.

The server of the real contact center may connect a consultation channel between a customer in at least one metaverse platform and a consultant of the real contact center.

In this manner, the present invention may connect the consultation channel with the consultant of the customer company in the real world while using the SNS on the metaverse platform.

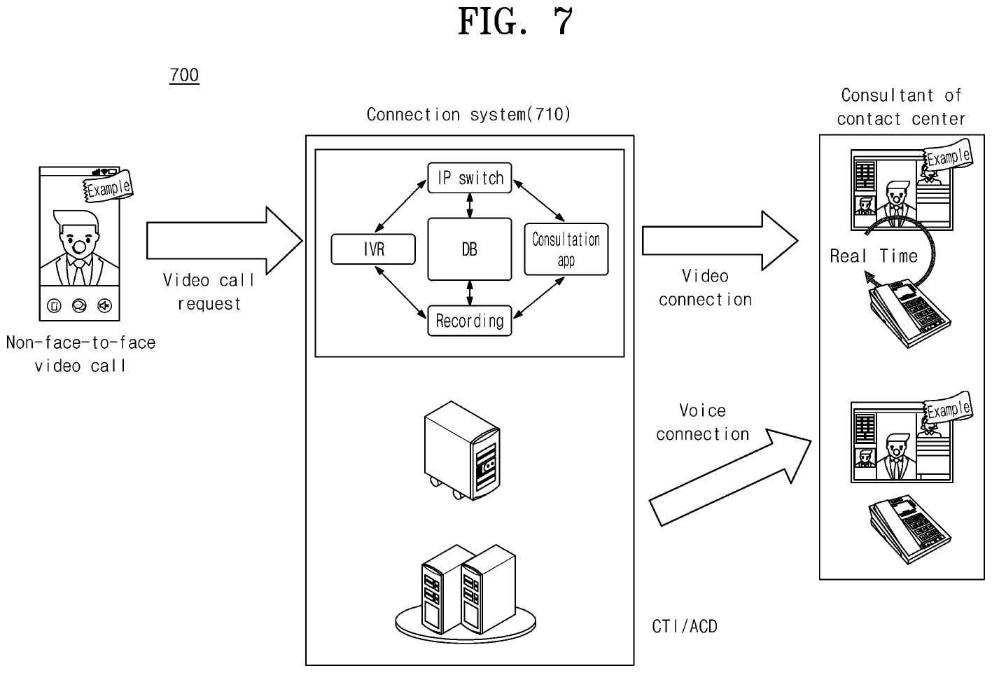

FIG. 7 illustrates an example 700 of an interworking video consultation according to an example embodiment.

A connection system 710 according to the present invention may connect a consultation channel between a customer that requests a non-face-to-face video call on a metaverse platform and a consultant of a contact center.

For example, when the customer is connected to a video call service provided on the metaverse platform, the connection system 710 may provide a virtual contact center to the customer connected to the video call service.

In detail, for example, the connection system 710 may separate voice and video from the customer connected to the video call service, may perform a video connection or a voice connection with the consultant of the contact center for the separated voice and video, respectively, and may connect the consultation channel through computer telephony integration (CTI)/automatic call distribution (ACD).

In this process, synchronization between the voice and the video may use general technologies required to provide an existing non-face-to-face video call service.

The connection system 710 may collect a consultation request based on a non-face-to-face video call from the customer and, in response to the collected consultation request, collect customer information on the customer that requests a consultation.

Also, the connection system 710 may determine a validity of the customer based on the customer information used for the non-face-to-face video call or to access the metaverse platform and may provide the customer information on the customer of which the validity is determined to a server of a real contact center.

The server of the real contact center may connect a consultation channel between a customer in at least one metaverse platform and a consultant of the real contact center.

In this manner, the present invention may connect the consultation channel with the consultant of the customer company in the real world while using the non-face-to-face video call on the metaverse platform.

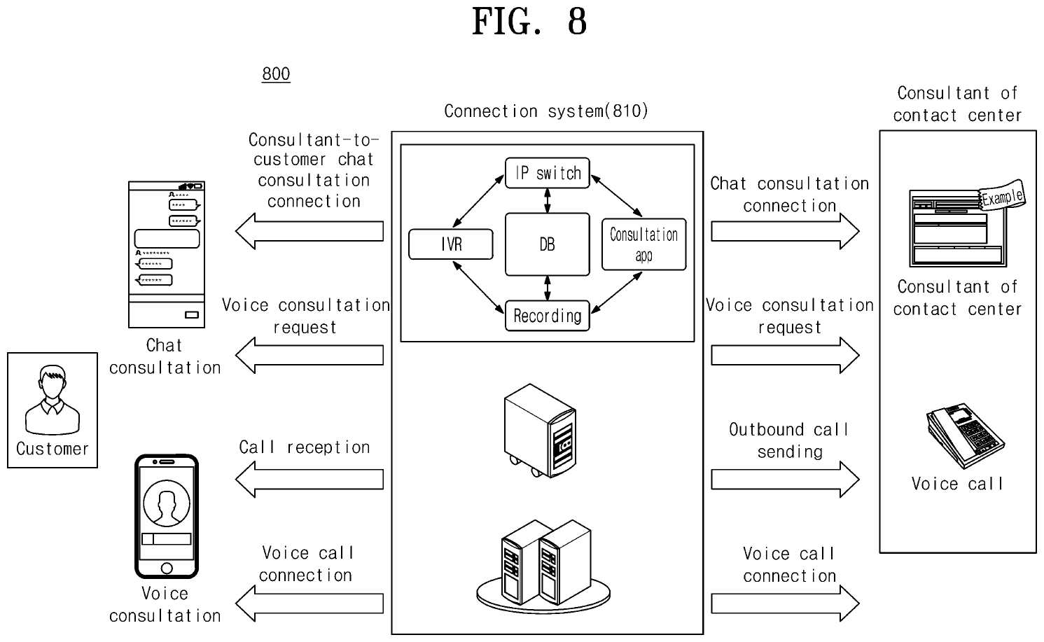

FIG. 8 illustrates an example of switching to a voice consultation during a chat consultation according to an example embodiment.

A connection system 810 according to the present invention may allow a customer of a metaverse platform to request a voice consultation with a consultant of a contact center during connection of a chat consultation with the consultant of the contact center of the real world on the metaverse platform.

Therefore, the connection system 810 according to an example embodiment may connect a voice-based consultation channel between the customer using the metaverse platform and a consultant of a customer company of the real world.

In detail, in response to a request from the customer connected to the metaverse platform, the connection system 810 according to an example embodiment may request a customer terminal and a terminal of the consultant of the contact center for a voice consultation.

Also, the connection system 810 according to an example embodiment may deliver an outbound call from the consultant of the contact center to the customer terminal of the real world.

When the customer terminal receives a call, the connection system 810 according to an example embodiment may set a voice call between the customer terminal and the terminal of the consultant of the contact center.

Also, the connection system 810 may collect a voice consultation request from the customer and, in response to the collected voice consultation request, collect customer information on the customer.

Since only a user that inputs personal information or is registered in advance may use the metaverse platform, the connection system 810 may collect information used to access the metaverse platform as the customer information on the customer that requests the consultation.

Also, the connection system 810 may determine a validity of the customer based on the c customer information, and may provide the customer information on the customer of which the validity is determined to a server of a real contact center.

The server of the real contact center may switch a consultation channel to a voice consultation channel during a chat consultation between a customer in at least one metaverse platform and the consultant of the real contact center.

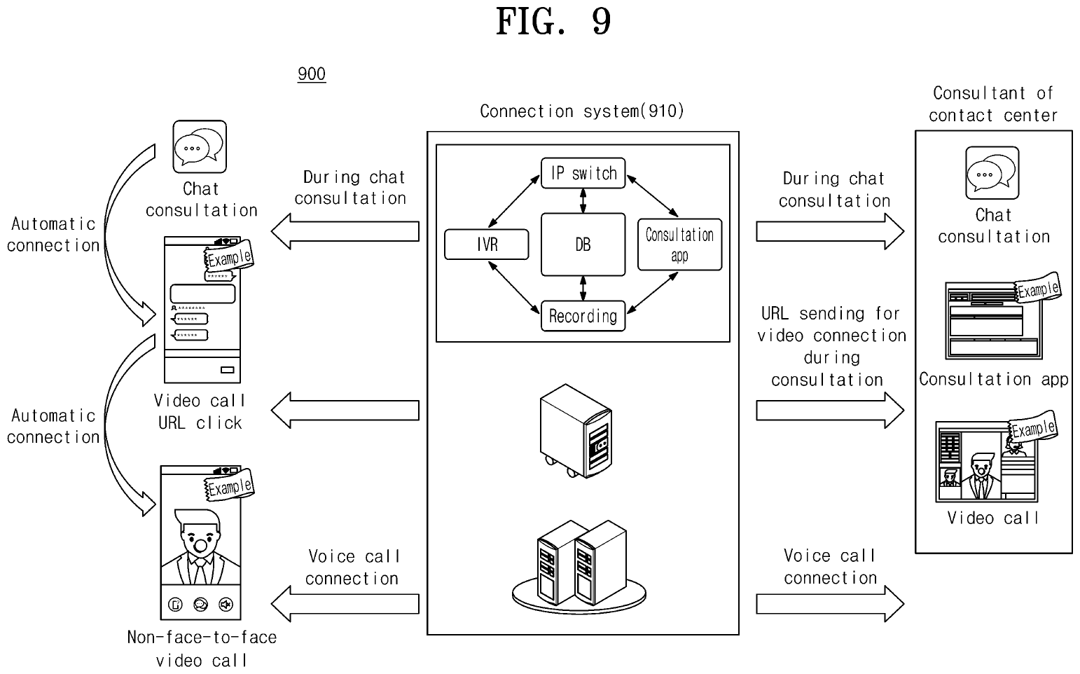

FIG. 9 illustrates an example of switching to a video consultation during a chat consultation according to an example embodiment.

A connection system 910 according to the present invention may request a video consultation with a consultant of a contact center during connection of a chat consultation with the consultant of the contact center of the real world on a metaverse platform through a customer of the metaverse platform.

Therefore, the connection system 910 according to an example embodiment may connect a non-face-to-face video call-based consultation channel between the customer using the metaverse platform and a consultant of a customer company of the real world.

In detail, in response to a request from the customer connected to the metaverse platform, the connection system 910 according to an example embodiment may request a customer terminal and a terminal of the consultant of the contact center for a video consultation.

Also, the connection system 910 according to an example embodiment may receive a video connection uniform resource locator (URL) from the consultant of the contact center and may provide the same to the customer terminal as link information for the non-face-to-face video call.

Therefore, in response to a selection on the video connection URL from the customer terminal, the connection system 910 according to an example embodiment may set a video call between the customer terminal and the terminal of the consultant of the contact center.

Also, the connection system 910 may collect a video consultation request from the customer and, in response to the collected video consultation request, collect the customer information on the customer.

Since only a user that inputs personal information or is registered in advance may use the metaverse platform, the connection system 910 may collect information used to access the metaverse platform as the customer information on the customer that requests the consultation.

Also, the connection system 910 may determine a validity of the customer based on the customer information, and may provide the customer information on the customer of which the validity is determined to a server of a real contact center.

The server of the real contact center may switch a consultation channel to a video consultation channel during a chat consultation between a customer in at least one metaverse platform and the consultant of the real contact center.

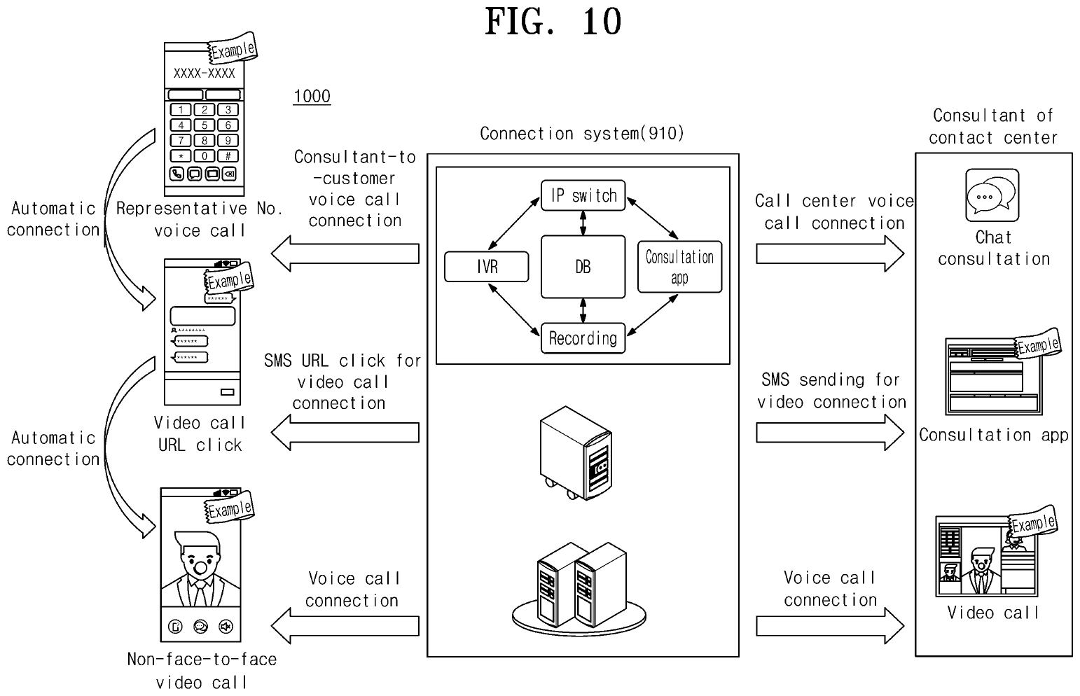

FIG. 10 illustrates an example of switching to a video consultation during a voice consultation according to an example embodiment.

A connection system 1010 according to the present invention may request a video consultation with a consultant of a contact center during connection of a voice consultation with the consultant of the contact center of the real world on a metaverse platform through a customer of the metaverse platform.

Therefore, the connection system 1010 according to an example embodiment may connect a non-face-to-face video call-based consultation channel between the customer using the metaverse platform and a consultant of a customer company of the real world.

In detail, in response to a request from the customer of which a voice call is connected to the consultant through the metaverse platform, the connection system 1010 according to an example embodiment may request a customer terminal and a terminal of the consultant of the contact center for a video consultation.

Also, the connection system 1010 according to an example embodiment may receive an SMS URL for video connection from the consultant of the contact center and may provide the same to the customer terminal as link information for the non-face-to-face video call.

Therefore, in response to a selection, for example, a click on the SMS URL for video connection from the customer terminal, the connection system 1010 according to an example embodiment may set a video call between the customer terminal and the terminal of the consultant of the contact center.

Also, the connection system 1010 may collect a video consultation request from the customer and, in response to the collected video consultation request, collect the customer information on the customer.

Since only a user that inputs personal information or is registered in advance may use the metaverse platform, the connection system 1010 may collect information used to access the metaverse platform as the customer information on the customer that requests the consultation.

Also, the connection system 1010 may determine a validity of the customer based on the customer information, and may provide the customer information on the customer of which the validity is determined to a server of a real contact center.

The server of the real contact center may switch a consultation channel to a video consultation channel during a chat consultation between a customer in at least one metaverse platform and the consultant of the real contact center.

According to the present invention, it is possible to provide technology for connecting a virtual world and a real world such that a user visiting a consultation center of the virtual world implemented in a metaverse may make a consultation through a consultation center of the real world using chat, voice, and video channels.

Also, it is possible to perform general inquiry, production subscription, purchase, and payment actions performed in a contact center (or a consultation center) through a connection from various metaverse platforms to a customer service center of the real world.

The apparatuses described herein may be implemented using hardware components, software components, and/or a combination thereof. For example, apparatuses and components described herein may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A connection system for connecting a metaverse of a virtual world and a contact center of a real world, the connection system comprising:
a contact center provider configured to provide a virtual contact center in at least one metaverse platform and to collect a consultation request through the provided virtual contact center;
a validity determiner configured to, in response to the collected consultation request, collect customer information on a user that requests a consultation and determine a validity of the user based on the collected customer information; and
a consultation processing unit configured to provide the customer information on the user of which the validity is determined to a server of a real contact center and to connect a consultation channel between a user in the at least one metaverse platform and the real contact center.

2. The connection system of claim 1, wherein the consultation processing unit is configured to connect a consultation channel communicable using at least one method among chat, voice, and video.

3. The connection system of claim 1, further comprising:
a billing processing unit configured to relay a billing for a virtual order request that occurs in the at least one metaverse platform to be processed in an actual financial institution; and
an order processing unit configured to generate order information corresponding to the billed virtual order request and to deliver the generated order information to a store terminal of the real world.

4. A connection system for connecting a contact center in a metaverse of a virtual world, the connection system comprising:
a contact center provider configured to provide a virtual contact center in a first metaverse platform and to collect a consultation request through the provided virtual contact center;
a validity determiner configured to, in response to the collected consultation request, collect customer information on a user that requests a consultation and determine a validity of the user based on the collected customer information; and
a consultation processing unit configured to provide the customer information on the user of which the validity is determined to a contact center in a second metaverse platform and to connect a consultation channel between a user in the first metaverse platform and the contact center in the second metaverse platform.

5. The connection system of claim 4, wherein the consultation processing unit is configured to, in response to a termination of a consultation channel between contact centers in the second metaverse platform, provide the customer information on the user of which the validity is determined to a server of a real contact center and connect a consultation channel between a user in the at least one metaverse platform and the real contact center.

6. A method of connecting a metaverse of a virtual world and a contact center of a real world, the method comprising:
providing a virtual contact center in at least one metaverse platform;
collecting a consultation request through the provided virtual contact center;
in response to the collected consultation request, collecting customer information on a user that requests a consultation;
determining a validity of the user based on the collected customer information; and
providing the customer information on the user of which the validity is determined to a server of a real contact center and connecting a consultation channel between a user in the at least one metaverse platform and the real contact center.

7. The method of claim 6, wherein the connecting of the consultation channel comprises connecting a consultation channel communicable using at least one method among chat, voice, and video.

8. The method of claim 6, further comprising:
relaying a billing for a virtual order request that occurs in the at least one metaverse platform to be processed in an actual financial institution.

9. The method of claim 8, further comprising:
generating order information corresponding to the billed virtual order request; and
delivering the generated order information to a store terminal of the real world.

10. A method of connecting a contact center in a metaverse of a virtual world, the method comprising:
providing a virtual contact center in a first metaverse platform and collecting a consultation request through the provided virtual contact center;
in response to the collected consultation request, collecting customer information on a user that requests a consultation;
determining a validity of the user based on the collected customer information;
providing the customer information on the user of which the validity is determined to a contact center in a second metaverse platform and connecting a consultation channel between a user in the first metaverse platform and the contact center in the second metaverse platform;
in response to a termination of a consultation channel between contact centers in the second metaverse platform, providing the customer information on the user of which the validity is determined to a server of a real contact center; and
connecting a consultation channel between a user in the first metaverse platform and the contact center in the second metaverse platform.
